(19) United States
(12) Patent Application Publication
(10) Pub. No.: US 2008/0101395 A1
(43) Pub. Date: May 1, 2008

(54) System and Method for Networking Computer Clusters

(75) Inventor: James D. Ballew, Grapevine, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 11/554,512

(22) Filed: Oct. 30, 2006

(51) Int. Cl. H04L 12/56

(52) U.S. Cl. 370/408; 370/386

(57) ABSTRACT

In a method embodiment, a method for networking a computer cluster system includes communicatively coupling a plurality of network nodes of respective ones of a plurality of sub-arrays, each network node operable to route, send, and receive messages. The method also includes communicatively coupling at least two of the plurality of sub-arrays through at least one core switch.

### TECHNICAL FIELD OF THE INVENTION

This invention relates to computer systems and, in particular, to computer network clusters having an enhanced scalability and bandwidth.

### BACKGROUND

The computing needs for high performance computing continues to grow. Commodity processors have become powerful enough to apply to some problems, but often must be scaled to thousands or even tens of thousands of processors in order to solve the largest of problems. However, traditional methods of interconnecting these processors to form networked computer cluster networks are problematic for a variety of reasons.

### SUMMARY

In certain embodiments, a computer cluster network includes a plurality of sub-arrays each comprising a plurality of network nodes each operable to route, send, and receive messages. The computer network cluster also includes a plurality of core switches each communicatively coupled to at least one other core switch and each communicatively coupling together at least two of the plurality of sub-arrays.

In a method embodiment, a method for networking a computer cluster system includes communicatively coupling a plurality of network nodes of respective ones of a plurality of sub-arrays, each network node operable to route, send, and receive messages. The method also includes communicatively coupling at least two of the plurality of sub-arrays through at least one core switch.

Particular embodiments of the present invention may provide one or more technical advantages. Teachings of some embodiments recognized network fabric architectures and rack-mountable implementations that support highly scalable computer cluster networks. Various embodiments may additionally support an increased bandwidth that minimizes the network traffic limitations associated with conventional mesh topologies. In some embodiments, the enhanced bandwidth and scalability is effected in part by network fabrics having short interconnects between network nodes and a reduction in the number of switches disposed in communication paths between distant network nodes. In addition, some embodiments may make the implementation of network fabrics based on sub-arrays of network nodes more practical.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is made to the following descriptions, taken in conjunction with the accompanying drawings, in which:

FIG. 1 is a block diagram illustrating an example embodiment of a portion of a computer cluster network;

FIG. 2 illustrates a block diagram of one embodiment of one of the network nodes of the computer cluster network of FIG. 1;

FIG. 3 illustrates a block diagram of one embodiment of a portion of the computer cluster network of FIG. 1 having thirty-six of the network nodes of FIG. 2 interconnected in a six-by-six, two-dimensional sub-array;

FIG. 4 illustrates a block diagram of one embodiment of a portion of the computer cluster network of FIG. 1 having a plurality of the sub-arrays of FIG. 3 interconnected by core switches;

FIG. 5 illustrates a block diagram of one embodiment of a portion of the computer cluster network of FIG. 1 having the X-axis dimension of a sub-array arranged in a single equipment rack;

FIG. 6 illustrates a block diagram of one embodiment of a portion of the computer cluster network of FIG. 4 having the X-axis dimension of a sub-array arranged in multiple equipment racks;

FIG. 7 illustrates a block diagram of one embodiment of the computer cluster of FIG. 4 having Y-axis connections interconnecting and extending through the multiple equipment racks; and

FIG. 8 illustrates a block diagram of one embodiment of a portion of the computer cluster network of FIG. 1 having each of the sub-arrays of FIG. 4 positioned within respective multiples of the computer racks illustrated in FIGS. 6 and 7.

### DESCRIPTION OF EXAMPLE EMBODIMENTS

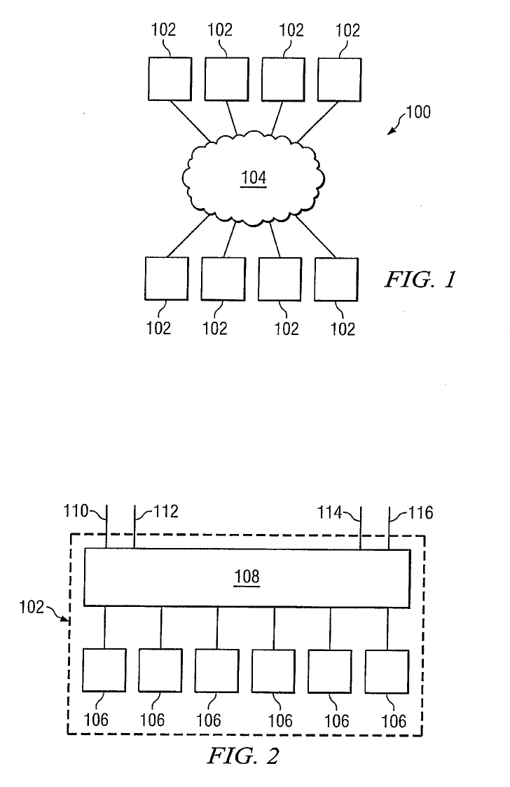

In accordance with the teachings of the present invention, a computer cluster network having an improved network fabric and a method for the same are provided. Embodiments of the present invention and its advantages are best understood by referring to FIGS. 1 through 8 of the drawings, like numerals being used for like and corresponding parts of the various drawings. Particular examples specified throughout this document are intended for example purposes only, and are not intended to limit the scope of the present disclosure. Moreover, the illustrations in FIGS. 1 through 8 are not necessarily drawn to scale.

FIG. 1 is a block diagram illustrating an example embodiment of a portion of a computer cluster network 100. Computer cluster network 100 generally includes a plurality of network nodes 102 communicatively coupled or interconnected by a network fabric 104. As will be shown, in various embodiments, computer cluster network 100 may include an enhanced performance computing system that supports high bandwidth operation in a scalable and cost-effective configuration.

As described further below with reference to FIG. 2, network nodes 102 generally refer to any suitable device or devices operable communicate with network fabric 104 by routing, send, and/or receiving messages. For example, network nodes 102 may include switches, processors, memory, input-output, and any combination of the proceeding. Network fabric 104 generally refers to any interconnecting system capable of communicating audio, video, signals, data, messages, or any combination of the preceding. In general, network fabric 104 includes a plurality of networking elements and connectors that together establish communication paths between network nodes 102. As will be shown, in various embodiments, network fabric 104 may include a plurality of switches interconnected by short copper cables, thereby enhancing frequency and bandwidth.

As computer performance has increased, the network performance required to support the higher processing rates has also increased. In addition, some computer cluster networks are scaled to thousands and even tens of thousands of processors in order to solve the largest of problems. In many instances, conventional network fabric architectures inadequately address both bandwidth and scalability concerns. For example, many conventional network fabrics utilize fat-tree architectures that often are cost prohibitive and have limited performance due to long cable lengths. Other conventional network fabrics that utilize mesh topologies may limit cable length by distributing switching functions across the network nodes. However, such mesh topologies typically have network traffic limitations, due in part to the increase in switches disposed in the various communication paths. Accordingly, teachings of some of the embodiments of the present invention recognized network fabric 104 architectures and rack-mountable implementations that support highly scalable computer cluster networks. Various embodiments may additionally support an increased bandwidth that minimizes the network traffic limitations associated with conventional mesh topologies. As will be shown, in some embodiments, the enhanced bandwidth and scalability is effected in part by network fabrics 104 having short interconnects between network nodes 102 and a reduction in the number of switches disposed in communication paths between distant network nodes 102. In addition, some embodiments may make the implementation of network fabrics 104 based on sub-arrays of network nodes 102 more practical. An example embodiment of a network node 102 configured for a two-dimensional sub-array is illustrated in FIG. 2.

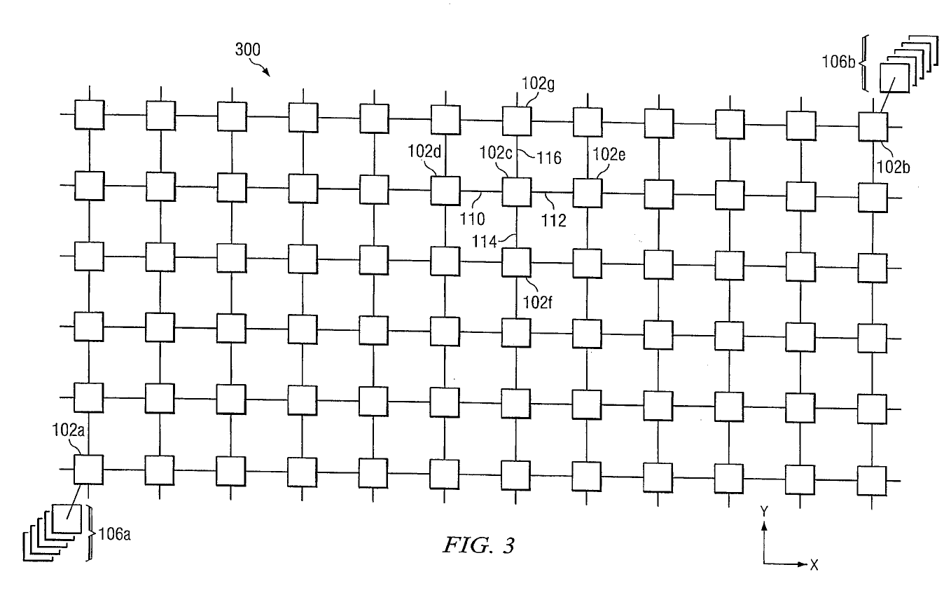

FIG. 2 illustrates a block diagram of one embodiment of one of the network nodes 102 of the computer cluster network 100 of FIG. 1. In this particular embodiment, network node 102 generally includes multiple clients 106 coupled to a switch 108 having external interfaces 110, 112, 114, and 116 for operation in a two-dimensional network fabric 104. Switch 108 generally refers to any device capable of routing audio, video, signals, data, messages, or any combination of the preceding. Clients 106 generally refer to any device capable of routing, communicating and/or receiving a message. For example, clients 106 may include switches, processors, memory, input-output, and any combination of the proceeding. In this particular embodiment, clients 106 are commodity computers 106 coupled to switch 108. The external interfaces 110, 112, 114, and 116 of switch 108 couple to respective connectors operable to support communications in the −X, +X, −Y, and +Y directions respectively of a two-dimensional sub-array. Various other embodiments may support network fabrics having three or more dimensions. For example, a three-dimensional network node of various other embodiments may have six interfaces operable to support communications in the −X, +X, −Y, +Y, −Z, and +Z directions. Networks with higher dimensionality may require an appropriate increase in the number of interfaces out of the network nodes 102. An example embodiment of a network nodes 102 arranged in a two-dimensional sub-array is illustrated in FIG. 3.

FIG. 3 illustrates a block diagram of one embodiment of a portion of the computer cluster network 100 of FIG. 1 having thirty-six of the network nodes 102 of FIG. 2 interconnected in a twelve-by-six, two-dimensional sub-array 300. In this particular embodiment, each network node 102 couples to each of the physically nearest or neighboring network nodes 102, resulting in very short network fabric 104 interconnections. For example, network node 102c couples to network nodes 102d, 102e, 102f, and 102g through interfaces and associated connectors 110, 112, 114 and 116 respectively. In various embodiments, the short interconnections may be implemented using inexpensive copper wiring operable to support very high data rates.

In this particular embodiment, the communication path between network nodes 102a and 102b includes the greatest number of intermediate network nodes 102 or switch hops for sub-array 300. For purposes of this disclosure, the term switch “hop” refers to communicating a message through a particular switch 108. For example, in this particular embodiment, a message from one of the commodity computers 106a to one of the commodity computers 106b must pass or hop through seventeen switches 108 associated with respective network nodes 102. In the +X direction, the switch hops include twelve of the network nodes 102, including the switch 108 of network node 102a. In the +Y direction, the hops include five other network nodes 102, including the switch 108 associated with network node 102b. As the size of computer cluster 100 increases, the number of intermediate network nodes 102 and respective switch hops of the various communication paths may reach the point where delays and congestion affect overall performance.

Various other embodiments may reduce the greatest number of switch hops by using, for example, a three-dimensional architecture for each sub-array. To illustrate, the maximum number of switch hops between corners of a two-dimensional sub-array of 576 network nodes 102 is 24+23=47 hops. A three-dimensional architecture configured as an eight-by-eight-by-nine sub-array reduces the maximum hop count to 8+7+7=22 hops. As explained further below, if the array were folded into a two-dimensional Torus, the maximum number of hops would be 13+12=25. Folding the sub-array into a three-dimensional Torus, configured as an eight-by-eight-by-nine array, reduces the maximum number of hops to 5+4+5=14.

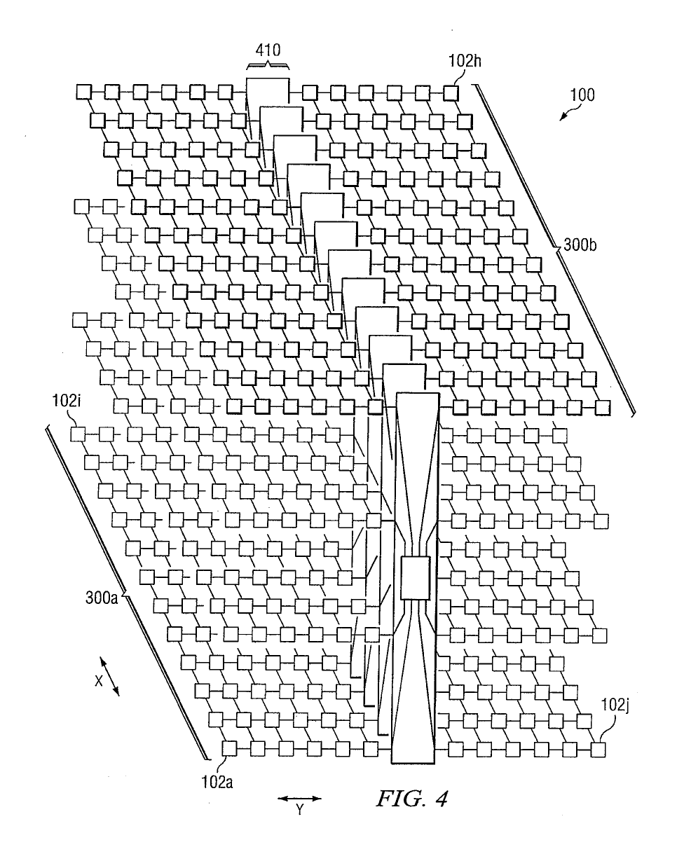

Computer cluster network 100 may include a plurality of sub-arrays 300. In various embodiments, the network nodes 102 of one sub-array 300 may be operable to communicate with the network nodes 102 of another sub-array 300. Interconnecting sub-arrays 300 of computer cluster network 100 may be effected by any of a variety of network fabrics 104. An example embodiment of a network fabric 104 that adds the equivalent of one dimension operable to interconnect multi-dimensional sub-arrays is illustrated in FIG. 4.

FIG. 4 illustrates a block diagram of one embodiment of a portion of the computer cluster network 100 of FIG. 1 having a plurality of the sub-arrays 300 of FIG. 3 interconnected by core switches 410. For purposes of this disclosure and in the following claims, the term “core switch” refers to a switch that interconnects a sub-array with at least one other sub-array. In this particular embodiment, computer cluster network 100 generally includes 576 network nodes (e.g., network nodes 102a, 102h, 102i, and 102j) partitioned into eight separate six-by-twelve sub-arrays (e.g., sub-arrays 300a and 300b), each sub-array having an edge connected to a set of twelve 8-port core switches 410. Various other embodiments may alternatively use three-dimensional sub-arrays. In such embodiments, each sub-array may couple to one or more core switches, for example, along two orthogonal edges of the sub-array. This particular embodiment reduces the maximum number of switch hops compared to conventional two-dimensional network fabrics by almost a factor of two. To illustrate, communication between commodity computers 106 of network nodes 102a and 102h includes twenty-four switch hops, the maximum for this example configuration. The communication path may include the entire length of the Y-axis, (through twelve network nodes 102), the remainder of the X-axis, (through eleven network nodes 102), and through one of the 8-port core switches 410.

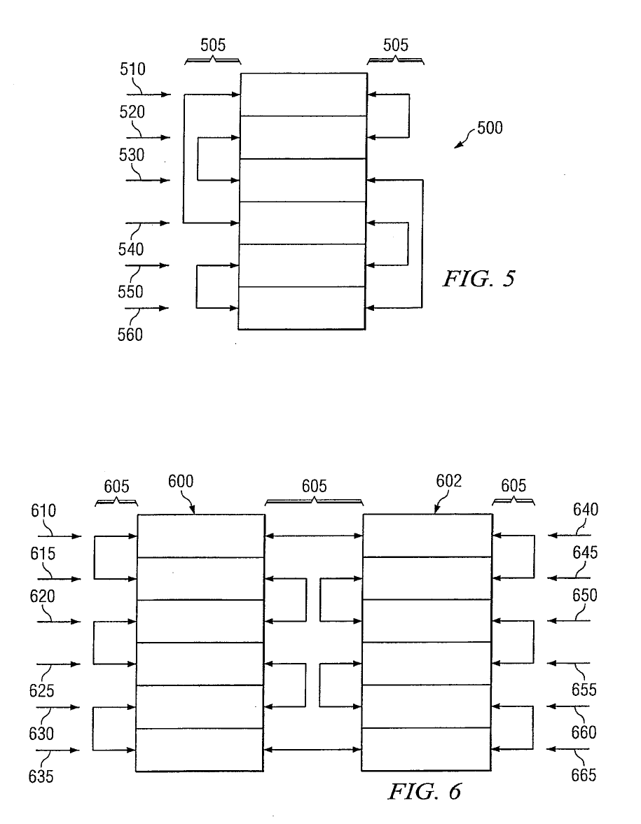

Various other embodiments may reduce the maximum number of switch hops even further. For example, each sub-array 300 may be folded into a two-dimensional Torus by interconnecting each network node disposed along an edge of the X-axis with respective ones disposed on the opposite edge (e.g., interconnecting client nodes 102a and 102i and so forth). Such a configuration reduces the maximum number of switch hops to 6+11+1=18. In addition, each sub-array 300 may be folded along the Y-axis, for example, by interconnecting the network nodes disposed along an edge of the Y-axis of two sub-arrays (e.g., interconnecting 102a and 102j and so forth). In such Torus configurations, with folded connections along the X-axis and the Y-axis, the maximum number of switch hops is 6+6+1=13, which is a greater reduction of hops than that achieved by arranging all of the network nodes 102 in one conventional three-dimensional Torus architecture. Various example embodiments of how a computer cluster network 100 may fit into the mechanical constraints of real systems is illustrated in FIGS. 5 through 7.

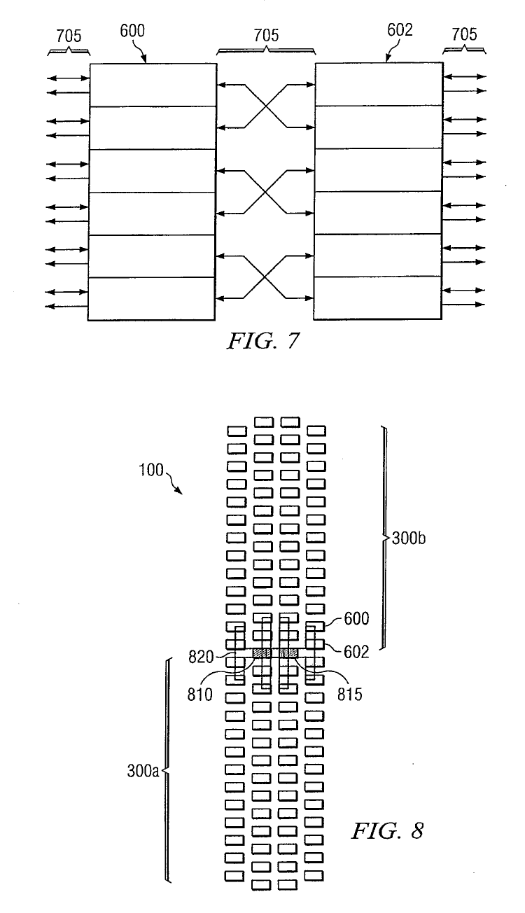

FIG. 5 illustrates a block diagram of one embodiment of a portion of the computer cluster network 100 of FIG. 1 having the X-axis dimension of a sub-array 300 arranged in a single equipment rack 500. In this particular embodiment, equipment rack 500 generally includes six Blade Server, 9U chassis 510, 520, 530, 540, 550, and 560. Each chassis 510, 520, 530, 540, 550, and 560 contains twelve dual processor blades plus a switch with four network interfaces, which enables each chassis to be connected in a two-dimensional array. Copper cables 505 interconnect the chassis 510, 520, 530, 540, 550, and 560 as shown. Although this example uses copper cables, any appropriate connector may be used. If the X dimension of the sub-array is less than six, then the sub-array connections may be contained in a single rack as shown in FIG. 5. Various other embodiments may use multiple racks to connect a particular dimension of each sub-array. One example embodiment illustrating the mechanical layout of such multiple-rack configurations is illustrated in FIGS. 6 and 7.

FIG. 6 illustrates a block diagram of one embodiment of a portion of the computer cluster network 100 of FIG. 4 having the X-axis dimension of a sub-array 300 arranged in multiple equipment racks (e.g., equipment racks 600 and 602). In this particular embodiment, each equipment rack 600 and 602 generally includes six Blade Server, 9U chassis 610, 615, 620, 625, 630, and 635 and 640, 645, 650, 655, 660, and 665 respectively. Each chassis 610, 615, 620, 625, 630, 635, 640, 645, 650, 655, 660, and 665 contains twelve dual processor blades plus a switch with four network interfaces, which enables each chassis to be connected by copper cables 605 in a two-dimensional array. Although this example uses copper cables, any appropriate connector may be used. This particular embodiment uses two equipment racks 600 and 602 to contain the 12X, X-axis dimension of each sub-array 300. In addition, this particular embodiment replicates the two equipment racks six times for the 6X, Y-axis dimension of each sub-array 300. Thus, each sub-array 300 is contained within twelve equipment racks.

As shown in FIG. 7, copper cables 705 interconnect and extend through equipment racks 600 and 602 to form the Y-axis connections of each sub-array 300. Although this example uses copper cables, any appropriate connector may be used. In this particular embodiment, all of the connections for the Y-axis are exposed within the two racks at the end of a row of cabinets. This makes it possible to interconnect the Y-axis of each of sub-array 300 to core switches 410 using short copper cables that allow high bandwidth operation. An equipment layout showing such an embodiment is illustrated in FIG. 8.

FIG. 8 illustrates a block diagram of one embodiment of a portion of the computer cluster network 100 of FIG. 4 having a plurality of the sub-arrays 300 positioned within respective multiples of the equipment racks 600 and 602 illustrated in FIGS. 6 and 7. In this particular embodiment, computer cluster network 100 generally includes eight sub-arrays (e.g., sub-arrays 300a and 300b) positioned within ninety-six equipment racks (e.g., equipment racks 600 and 602), and twelve core switches 410 positioned within two other equipment racks 810 and 815. Each sub-array includes twelve of the ninety-six sub-array equipment racks. The core switch equipment racks 810 and 815 are positioned proximate a center of computer cluster network 100 to minimize the length of the connections between equipment racks 810 and 815 and each sub-array (e.g., sub-arrays 300a and 300b). Wire ducts 820 facilitate the copper-cable connections between each sub-array 300 and equipment racks 810 and 815 containing the core switches 410. In this particular configuration, the longest cable of computer cluster network 100, including all of interconnections of the ninety-eight equipment racks (e.g., equipment racks 600, 602, 810, and 815), is less than six meters. Embodiments using three-dimensional sub-arrays, such as, for example, six-by-four-by-three sub-arrays, may further reduce the maximum cable routing distance. Various other embodiments may include fully redundant communication paths interconnecting each of the network nodes 102. The fully redundant communication paths may be effected, for example, by doubling the core switches 410 to a total of twenty-four core switches 410.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A computer cluster network comprising:
a plurality of sub-arrays each comprising a plurality of network nodes positioned within one or more first equipment racks, each network node operable to route, send, and receive messages;
a plurality of core switches each communicatively coupled to at least one other of the plurality of core switches, each communicatively coupling together at least two of the plurality of sub-arrays, and each positioned within one or more second equipment racks;
a plurality of copper cables each communicatively coupling respective at least one of the one or more first equipment racks with at least one of the one or more second equipment racks;
wherein the longest copper cable of the plurality of copper cables is less than ten meters; and
wherein the one or more first equipment racks are positioned proximate a center of the one or more second equipment racks.

2. A computer cluster network comprising:
a plurality of sub-arrays each comprising a plurality of network nodes each operable to route, send, and receive messages; and
a plurality of core switches each communicatively coupled to at least one other core switch and each communicatively coupling together at least two of the plurality of sub-arrays.

3. The computer cluster network of claim 2, wherein each network node of the plurality of network nodes comprises one or more switches each communicatively coupled to one or more clients selected from the group consisting of:
a processor;
a memory element;
an input-output element; and
a commodity computer.

4. The computer cluster network of claim 2, wherein the plurality of network nodes of each of the plurality of sub-arrays comprises network architecture selected from the group consisting of:
a single-dimensional array;
a multi-dimensional array; and
a multi-dimensional Torus array.

5. The computer cluster network of claim 2, wherein each core switch is communicatively coupled to respective at least one of the plurality of network nodes of each of the respective at least two of the plurality of sub-arrays.

6. The computer cluster network of claim 5, wherein each of the respective at least one of the plurality of network nodes is disposed along at least one edge of the respective at least two of the plurality of sub-arrays.

7. The computer cluster network of claim 2, and further comprising:
a cabinet system comprising:
one or more first equipment racks each operable to receive the plurality of network nodes of each of the plurality of sub-arrays;
one or more second equipment racks each operable to receive the plurality of core switches;
wherein the one or more first equipment racks are positioned proximate a center of the cabinet system.

8. The computer cluster network of claim 7, and further comprising a plurality of connectors each communicatively coupling respective at least one of the one or more first equipment racks with at least one of the one or more second equipment racks.

9. The computer cluster network of claim 8, wherein the longest connector of the plurality of connectors is less than ten meters.

10. The computer cluster network of claim 8, wherein the plurality of connectors comprise a plurality of copper cables.

11. A method of networking a computer cluster system comprising:
communicatively coupling a plurality of network nodes of respective ones of a plurality of sub-arrays, each network node operable to route, send, and receive messages;
communicatively coupling at least two of the plurality of sub-arrays through at least one core switch.

12. The method of claim 11, wherein communicatively coupling a plurality of network nodes comprises communicatively coupling a plurality of switches each coupled to respective one or more clients selected from the group consisting of:
a processor;
a memory element;
an input-output element; and
a commodity computer.

13. The method of claim 11, and further comprising configuring each sub-array of the respective ones of a plurality of sub-arrays with network architecture selected from the group consisting of:
a single-dimensional array;
a multi-dimensional array; and
a multi-dimensional Torus array.

14. The method of claim 11, and further comprising communicatively coupling each sub-array of the respective ones of a plurality of sub-arrays with each other sub-array of the plurality of sub-arrays through one or more of the at least one core switch.

15. The method of claim 14, and further comprising communicatively coupling each of the one or more of the at least one core switch to respective at least one of the plurality of network nodes.

16. The method of claim 15, wherein communicatively coupling each of the one or more of the at least one core switches to respective at least one of the plurality of network nodes comprises communicatively coupling each of the one or more of the at least one core switches to respective at least one of the plurality of network nodes disposed along at least one edge of the respective ones of a plurality of sub-arrays.

17. The method of claim 11, and further comprising:
mounting each of the respective ones of the plurality of sub-arrays in one or more first equipment racks;
mounting each of the at least one core switches in one or more second equipment racks; and
positioning the second equipment racks proximate a center of the first equipment racks.

18. The method of claim 17, and further comprising communicating between the respective ones of the plurality of sub-arrays of the one or more first equipment racks and the at least one core switches of the one or more second equipment racks through a plurality of connectors.

19. The method of claim 18, wherein communicating through a plurality of connectors comprises communicating through a plurality of copper cables.

20. The method of claim 19, wherein communicating through a plurality of copper cables comprises communicating through a plurality of copper cables that are each less than ten meters in length.
